(19) United States
(12) Patent Application Publication
(10) Pub. No.: US 2013/0336515 A1
(43) Pub. Date: Dec. 19, 2013

(54) Y-SHAPED HEADPHONE / EARBUD CORD SLEEVE

(71) Applicant: Anthony John Centrilla, III, Carmel, NY (US)

(72) Inventor: Anthony John Centrilla, III, Carmel, NY (US)

(21) Appl. No.: 13/526,243

(22) Filed: Jun. 18, 2012

(51) Int. Cl. H01B 7/00; H04R 1/10

(52) U.S. Cl. 381/384; 174/135

(57) ABSTRACT

The present invention relates generally to a Y-shaped cord sleeve. More particularly, the invention encompasses a Y-shaped headphone/earbud cord sleeve. The present invention is also directed to a novel placement of at least one opening at or near a Y-junction of the Y-shaped cord sleeve. The present invention is also directed to a novel Y-shaped cord sleeve that has at least one accommodation or opening for a microphone and/or volume control or similar electronic input/output type device. The Y-shaped cord sleeve could also have at least one tab, medallion, or tongue to cover at least a portion of the opening for the headphone/earbud cord. The user could also personalize or individualize, or create an expression using any of the features of this invention.

### FIELD OF THE INVENTION

The present invention relates generally to a Y-shaped cord sleeve. More particularly, the invention encompasses a Y-shaped headphone/earbud cord sleeve. The present invention is also directed to a novel placement of at least one opening at or near a Y-junction of the Y-shaped cord sleeve. The present invention is also directed to a novel Y-shaped cord sleeve that has at least one accommodation or opening for a microphone and/or volume control or similar electronic input/output type device. The Y-shaped cord sleeve could also have at least one tab, medallion, or tongue to cover at least a portion of the opening for the headphone/earbud cord. The user could also personalize or individualize, or create an expression using any of the features of this invention.

### BACKGROUND INFORMATION

Ever-increasing popularity of mobile devices, i.e. digital music players, iPod, iPad, headphones, laptops, to name a few, have brought about a wide use of earbud style headphones. The small, sleek and basic design of this type of headphones makes them ideal for use with mobile devices, as they can and often are stored in or around the mobile device, as well as in various small spaces, whether they be pockets, small bags, purses, etc. This type of usage and storage of earbuds often allows for the cords of the earbuds, in particular the cords of each individual earpiece to become tangled. Tangled cords can be harmful to the product itself, and even sometimes causes the earbuds to lose functionality, not to mention that the earbuds can be at times extremely difficult to untangle and cause the user much distress and inconvenience.

Current headphone/earbud management devices and solutions require the user to cease use in order to gain the advantages of tangle prevention/protection against various elements. In addition, the headphones/earbuds overwhelmingly come as they are with regard to their appearance and potential protection from the manufacturer.

Efforts to improve the basic design of an earpiece/earbud have had limited success.

U.S. Pat. No. 8,147,270 (Jeffrey Wescott), the entire disclosure of which is incorporated herein by reference, discloses a sleeve for storing a Y-shaped cord without tangling and a method of managing a Y-shaped cord by grouping a plurality of the cord loose ends in the sleeve, each into a separate portion, forming a closed loop. The sleeve is triangular-shaped, having a conical sidewall with an open top end and an open bottom end. Inside the sleeve, the ends of the cord are separated by at least one fastener. The closed loop makes it less likely that the cord will tangle with other objects or with itself. If the cord does tangle when in the closed loop, the topology of the closed loop makes untangling the cord simpler and quicker than if the ends were loose. When using the Y-cord, the sleeve remains on the cord, not interfering with the cord functioning and not easily lost.

U.S. Patent Publication No. 2008/0099229 (George Scifo, et al.), the entire disclosure of which is incorporated herein by reference, discloses an earpiece/wire organizer which houses and maintains wires in an untangled manner. The earpiece/wire organizer has a sleeve constructed with mating spine pieces that house wires therein to prevent or mitigate entanglement during storage and carrying. Simply scrunching or compressing the sleeve with a single hand motion engages the mating spine pieces in an attached configuration and compresses the sleeve and wire housed therein. When the user desires to lengthen or elongate the wire, the user simply pulls or elongates the sleeve with a single hand motion that disengages the mating spine pieces and lengthens the sleeve and wire housed therein. Where more than one sleeve is provided, the sleeves are further constructed to releaseably connect to one another.

U.S. Patent Publication No. 2009/0303667 (George Scifo, et al.), the entire disclosure of which is incorporated herein by reference, discloses an earpiece/wire organizer which houses and maintains wires in an untangled manner. The earpiece/wire organizer has a sleeve constructed with mating spine pieces having an interlocking self-adhering surface coat thereon, wherein the sleeve house wires therein to prevent or mitigate entanglement during storage and carrying. Simply scrunching or compressing the sleeve with a single hand motion engages the interlocking self-adhering surface of the mating spine pieces in an attached configuration and compresses the sleeve and wire housed therein. When the user desires to lengthen or elongate the wire, the user simply pulls or elongates the sleeve with a single hand motion that disengages the interlocking self-adhering surface of the mating spine pieces and lengthens the sleeve and wire housed therein. Where more than one sleeve is provided, the sleeves are further constructed to releasably connect to one another.

U.S. Patent Publication No. 2011/0056721 (Michelle Goodman), the entire disclosure of which is incorporated herein by reference, discloses a method and apparatus for keeping headphone and earpiece cables from tangling. The apparatus may include a flexible sleeve capable of moving relative to a headphone cord to restrict the movement of earpiece cables associated with the headphone cord.

U.S. Patent Publication No. 2011/0290532 (Miguel A. Cano, JR.), the entire disclosure of which is incorporated herein by reference, discloses a headphone cord sleeve which includes: a flexible tubular sleeve including an opening at each of a first end and a second end; a reinforced section of the tubular sleeve adjacent the first end reducing the flexibility of the tubular sleeve over the length of the reinforced section; and a loop extending from the side wall of the flexible tube, adjacent to the reinforced section. A method of managing a headphone cord comprising the steps of: providing a tubular sleeve including a first opening and a second opening; positioning the tubular sleeve onto a headphone cord, wherein the headphone cord includes a jack plug, a jack cord, a cord split, a pair of earbud cords and a pair of earbud housings; and selectively positioning the tubular sleeve between a use position and a storage position.

This invention improves on the deficiencies of the prior art and provides an inventive Y-shaped cord sleeve.

### PURPOSES AND SUMMARY OF THE INVENTION

The invention is a novel Y-shaped cord sleeve.

Therefore, one purpose of this invention is to provide a cost effective, durable, safe, and washable a Y-shaped headphone/earbud cord sleeve.

Another purpose of this invention is to provide a novel placement of at least one opening at or near a Y-junction of the Y-shaped cord sleeve.

Yet another purpose of this invention is to provide a novel Y-shaped cord sleeve that has at least one opening for a microphone and/or volume control or similar electronic input/output type device.

Still yet another purpose of this invention is to provide a Y-shaped cord sleeve that also has at least one tab to cover at least a portion of the opening for the headphone/earbud cord.

Therefore, in one aspect this invention comprises a Y-shaped sleeve, comprising; at least one first sleeve having a first end forming an opening and a second end; at least one second sleeve having a first end forming an opening and a second end; and at least one joint cord sleeve having a first end forming an opening and a second end; wherein each second end of each said sleeve is joined to form a sleeve Y-junction; and wherein said sleeve Y-junction having at least one opening, and thereby forming said Y-shaped sleeve.

In another aspect this invention comprises a combination Y-shaped sleeve and a Y-shaped cord, comprising:
(a) at least one first sleeve having a first end forming an opening and a second end, at least one second sleeve having a first end forming an opening and a second end, and at least one joint cord sleeve having a first end forming an opening and a second end, wherein each second end of each said sleeve is joined to form a sleeve Y-junction, and forming a Y-shaped sleeve;
(b) at least one first cord having a first end and a second end, at least one second cord having a first end and a second end, and at least one joint cord having a first end and a second end, wherein each second end of each said cord is joined to form a cord Y-junction, and forming a Y-shaped cord; and
(c) said sleeve Y-junction having at least one opening for the passage of said first cord, said second cord, and said joint cord, such that said first end of said first cord exits said first opening in said first sleeve, said first end of said second cord exits said first opening in said second sleeve, said first end of said joint cord exits said first opening in said joint sleeve, and wherein each of said second end of each of said cord are securely contained inside said sleeve Y-junction.

In yet another aspect this invention comprises a Y-shaped sleeve, comprising; at least one first sleeve having a first end forming an opening and a second end; at least one second sleeve having a first end forming an opening and a second end; and at least one joint cord sleeve having a first end forming an opening and a second end; wherein each second end of each said sleeve is joined to form a sleeve Y-junction; said sleeve Y-junction having at least one opening; at least one O-ring secured to at least one sleeve; and wherein said at least one O-ring provides tubular elasticity to said at least one sleeve.

### BRIEF DESCRIPTION OF THE DRAWINGS

Although the scope of the present invention is much broader than any particular embodiment, a detailed description of the preferred embodiment follows together with drawings. These drawings are for illustration purposes only and are not drawn to scale. Like numbers represent like features and components in the drawings. The invention may best be understood by reference to the ensuing detailed description in conjunction with the drawings in which:

FIG. 1 illustrates a front view of a first embodiment of the Y-shaped cord sleeve invention.

FIG. 2 illustrates a back view of a second embodiment of the Y-shaped cord sleeve invention.

FIG. 3 illustrates a back view of a third embodiment of the Y-shaped cord sleeve invention.

FIG. 4 illustrates a top view of a fourth embodiment of the Y-shaped cord sleeve invention.

FIG. 5 illustrates a front view of a fifth embodiment of the Y-shaped cord sleeve invention.

FIG. 6 illustrates a front view of a sixth embodiment of the Y-shaped cord sleeve invention.

### DETAILED DESCRIPTION

A Y-shaped headphone/earbud cord sleeve comprises of a one-piece or multi-piece sleeve that may or may not be seamless with a hole or slit or opening preferably at the center of the Y in which the user would feed each of the three components of the headphones through. This would allow the user to individualize, personalize, and protect (whether it be to protect from the elements, tangling or for any other reasons) of earbud cables while providing tangle resistance to the user while in use and/or in storage. The prior art earbud protection/tangle prevention items are different from this invention as they work to restrict movement of the earpiece cables in order to protect them. On the contrary, this invention does not impede movement, but allows for freedom of movement while offering protection. This invention is removable, replaceable, and also may be applied at or during manufacture of the actual headphone/earbud.

This invention is for a headphone/earbuds cord management device that allows the user to protect against tangling and the elements not only in storage, but in use. This invention allows the user to save time and steps toward using and protecting their earbuds/headphones. The inventive Y-shaped sleeve allows the user not only to individualize, personalize, and protect earbud cables, but also provides tangle resistance to the user while in storage, and also in use.

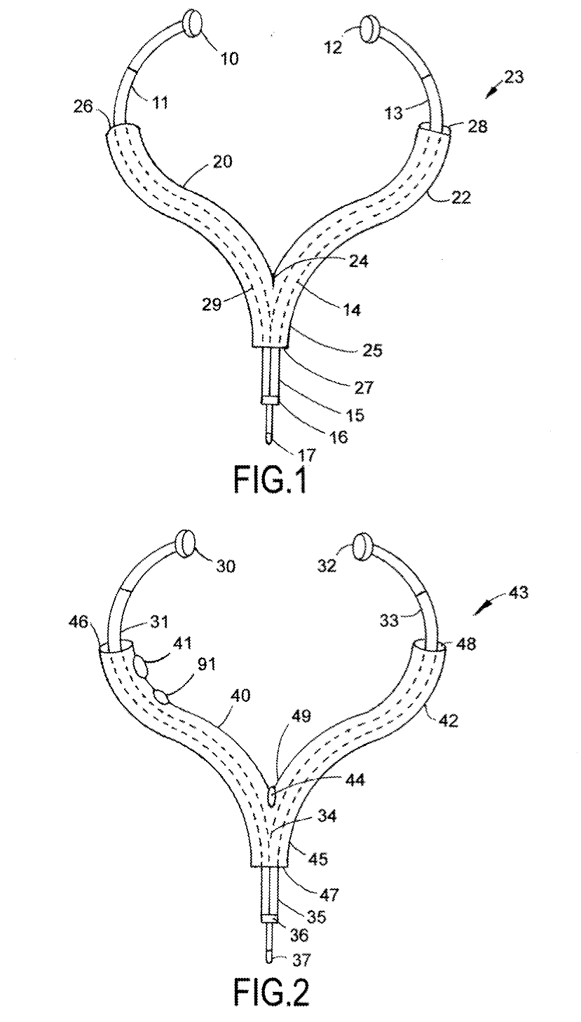

FIG. 1 illustrates a front view of a first embodiment of the Y-shaped cord sleeve invention 23. The Y-shaped cord sleeve 23, comprises of a first or right sleeve 20, having a first or right sleeve opening 26, a second or left sleeve 22, having a second or left sleeve opening 28, and a joint cord sleeve 25, having a joint cord sleeve opening 27, and forming a sleeve Y-junction 29. The Y-shaped cord sleeve 23, further comprises of at least one central opening 24, or Y-junction hole 24, or Y-junction slit 24, preferably at or near the sleeve Y-junction 29. The sleeve Y-junction 29, is formed by the intersection of the first sleeve 20, the second sleeve 22, and the joint cord sleeve 25. The at least one central opening 24, could be in the front, back, top, or side of the sleeve Y-junction 29. An earbud headphone 16, having a first or right cord 11, a second or left cord 13, which are joined at cord Y-junction 14, to form a joint cord 15. The earbud headphone 16, is associated with the Y-shaped cord sleeve 23, such that the first cord 11, is feed through the central opening 24, and it then is made to emerge out of the first sleeve opening 26. Similarly, the second cord 13, is feed through the central opening 24, and is then made to emerge out of the second sleeve opening 28. Similarly, the joint cord 15, is feed through the central opening 24, and is then made to emerge out of the joint cord sleeve opening 27. Once the earbud headphone 16, and the Y-shaped cord sleeve 23, have been associated, the cord Y-junction 14, will be substantially congruent with the sleeve Y-junction 29. The earbud headphones 16, typically have a first or right earpiece 10, at the end of the first or right cord 11, a second or left earpiece 12, at the end of the second or left cord 13, and a plug 17, at the end of the joint cord 15. The central opening 24, should be sufficiently big or expandable, such that, the first cord 11, first earpiece 10, second cord 13, second earpiece 12, joint cord 15, and the plug 17, can easily pass or feed-through the Y-junction hole 24.

As shown in FIG. 1, the earbud headphone cord sleeve 23, where the headphone cord sleeve 23, is a hollow, Y-shaped, one-piece or multi-piece flexible knit tube 23, including openings 26, 27, 28, at each end of the “Y’ shape with a hole 24, on the backside of the middle hub/cord split 24, in which the user will be able to feed the plug 17, and the two earpieces 10, 12, of the earbud headphone 16, through for use. FIG. 1 is merely one form in which the earbud headphone cord sleeve 23, may be embodied.

FIG. 2 illustrates a back view of a second embodiment of the Y-shaped cord sleeve invention 43. The Y-shaped cord sleeve 43, comprises of a first or right sleeve 40, having a first or right sleeve opening 46, a second or left sleeve 42, having a second or left sleeve opening 48, and a joint cord sleeve 45, having a joint cord sleeve opening 47, and forming a sleeve Y-junction 49. The Y-shaped cord sleeve 43, further comprises of at least one central opening 44, or Y-junction hole 44, or Y-junction slit 44, preferably at or near the sleeve Y-junction 49. The sleeve Y-junction 49, is formed by the intersection of the first sleeve 40, the second sleeve 42, and the joint cord sleeve 45. The at least one central opening 44, could be in the front, back, top, or side of the sleeve Y-junction 49. An earbud headphone 36, having a first or right cord 31, a second or left cord 33, which are joined at cord Y-junction 34, to form a joint cord 35. The earbud headphone 36, is associated with the Y-shaped cord sleeve 43, such that the first cord 31, is feed through the central opening 44, and it then is made to emerge out of the first sleeve opening 46. Similarly, the second cord 33, is feed through the central opening 44, and is then made to emerge out of the second sleeve opening 48. Similarly, the joint cord 35, is feed through the central opening 44, and is then made to emerge out of the joint cord sleeve opening 47. Once the earbud headphone 36, and the Y-shaped cord sleeve 43, have been associated, the cord Y-junction 34, will be substantially congruent with the sleeve)(junction 49. The earbud headphones 36, typically have a first or right earpiece 30, at the end of the first or right cord 31, a second or left earpiece 32, at the end of the second or left cord 33, and a plug 37, at the end of the joint cord 35. The earbud headphone 36, also has at least one control device 41. The earbud headphone 36, could also have at least one secondary device 91, such as, a microphone 91. The central opening 44, should be sufficiently big or expandable, such that, the first cord 31, first earpiece 30, second cord 33, second earpiece 32, joint cord 35, the plug 37, the control device 41, and the at least one secondary device 91, can easily pass or feed-through the Y-junction hole 44.

In FIG. 2, the earbud headphones 36, include a plug 37, a plug cord 35, a cord split 34, earpiece cords 31, 33, and earbuds 30, 32. The earbud headphone cord 31, 33, shown in FIG. 2, represents of a typical earbud headphone cord 31, 33, 35, such as for example that of an Apple earbuds. However, it is understood that there are various earbud headphone styles with numerous variations in earbud headphone styles and the Y-shaped earbud headphone sleeve may be adapted for use with numerous variations. For example, some earbud headphones 30, 32, may include a microphone 91, and/or volume control 41. The earbud headphone cord 36 may alternatively feature an accommodation for the microphone/volume control 41, on one of the earpiece cords 31, 33.

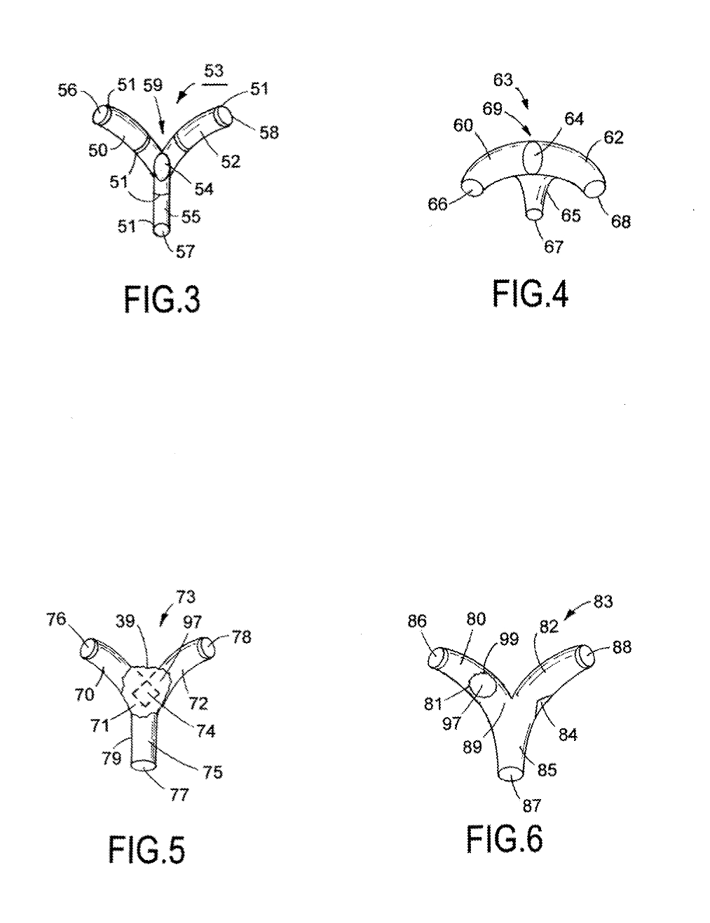

FIG. 3 illustrates a back view of a third embodiment of the Y-shaped cord sleeve invention 53. The Y-shaped cord sleeve 53, comprises of a first or right sleeve 50, having a first'or right sleeve opening 56, a second or left sleeve 52, having a second or left sleeve opening 58, and a joint cord sleeve 55, having a joint cord sleeve opening 57, and forming a sleeve Y-junction 59. The Y-shaped cord sleeve 53, further comprises of at least one central opening 54, or Y-junction hole 54, or Y-junction slit 54, preferably at or near the sleeve Y-junction 59. The sleeve Y-junction 59, is formed by the intersection of the first sleeve 50, the second sleeve 52, and the joint cord sleeve 55. The at least one central opening 54, could be in the front, back, top, or side of the sleeve Y-junction 59. The Y-shaped cord sleeve 53, could also be provided with at least one elastic-type O-ring 51, or similar such device 51. The one or more elastic-type O-ring 51, could be secured to the Y-shaped cord sleeve 53, at any or numerous locations, for example, they could be secured to the Y-shaped cord sleeve 53, at the end of the first sleeve opening 56, the second sleeve opening 58, the joint cord opening 57, at or near the Y-junction 59, to name a few, or along any portion of Y-shaped cord sleeve 53. One of the purposes of the o-ring 51, is to allow for a more secure or tight contact between the Y-shaped cord sleeve 53, and the earbud head phone 16, 36, and to prevent any slippage or any sliding.

FIG. 4 illustrates a top view of a fourth embodiment of the Y-shaped cord sleeve invention 63. The Y-shaped cord sleeve 63, comprises of a first or right sleeve 60, having a first or right sleeve opening 66, a second or left sleeve 62, having a second or left sleeve opening 68, and a joint cord sleeve 65, having a joint cord sleeve opening 67, and forming a sleeve Y-junction 69. The Y-shaped cord sleeve 63, further comprises of at least one central opening 64, or Y-junction hole 64, or Y-junction slit 64, preferably at or near the sleeve Y-junction 69. The sleeve Y-junction 69, is formed by the intersection of the first sleeve 60, the second sleeve 62, and the joint cord sleeve 65. The at least one central opening 64, could be in the front, back, top, or side of the sleeve Y-junction 69. As shown in FIG. 4, the central opening 64, is at the top of the sleeve Y-junction 69, such that once the Y-shaped cord sleeve 63, has been mated with the earbud headphone 16, 36, the central opening 64, would be less visible as it would be facing in an upward direction and would not be visible to an onlooker.

FIG. 5 illustrates a front view of a fifth embodiment of the Y-shaped cord sleeve invention 73. The Y-shaped cord sleeve 73, comprises of a first or right sleeve 70, having a first or right sleeve opening 76, a second or left sleeve 72, having a second or left sleeve opening 78, and a joint cord sleeve 75, having a joint cord sleeve opening 77, and forming a sleeve Y-junction 79. The Y-shaped cord sleeve 73, further comprises of at least one central opening 74, or Y-junction hole 74, or Y-junction slit 74, preferably at or near the sleeve Y-junction 79. The sleeve Y-junction 79, is formed by the intersection of the first sleeve 70, the second sleeve 72, and the joint cord sleeve 75. The at least one central opening 74, could be in the front, back, top, or side of the sleeve Y-junction 79. The Y-shaped cord sleeve 73, optionally has at least one medallion or tongue or tab or hub 39, that is secured via at least one securing means 71, to cover at least a portion of the central opening 74. The tab or medallion 39, could be securely placed along any portion of the Y-shaped cord sleeve 73, such as, in the front, back or side. The tab or tongue or medallion 39, could also be made a part of the Y-shaped cord sleeve 73, during production, so as to, for example, cover at least a portion of the central opening or hole 74. The tab 39, tongue 39, medallion 39, could also function as a decorative item 39, on the front of the Y-shaped sleeve 73, and could feature a message 97, such as, an inscription, design, indicia, a statement, a rhyme, an alphabet, a numeral, a symbol, a visual message, a graphic image, a verbiage, just to name a few.

FIG. 6 illustrates a front view of a sixth embodiment of the Y-shaped cord sleeve invention 83. The Y-shaped cord sleeve 83, comprises of a first or right sleeve 80, having a first or right sleeve opening 86, a second or left sleeve 82, having a second or left sleeve opening 88, and a joint cord sleeve 85, having a joint cord sleeve opening 87, and forming a sleeve Y-junction 89. The. Y-shaped cord sleeve 83, further comprises of at least one central opening 84, or Y-junction hole 84, or Y-junction slit 84, preferably at or near the sleeve Y-junction 89. The sleeve Y-junction 89, is formed by the intersection of the first sleeve 80, the second sleeve 82, and the joint cord sleeve 85. The at least one central opening 84, could be in the front, back, top, or side of the Y-junction 89. As shown in FIG. 6, the at least one central opening 84, or Y-junction hole 84, or Y-junction slit 84, is on the side of the Y-shaped cord sleeve 83. Optionally, the Y-shaped cord sleeve invention 83, could have at least one tab 99, tongue 99, medallion 99, that could be placed anywhere on the sleeve, including, but not limited to the front or back of the Y-junction 89, as a decorative or a design item. The tab 99, tongue 99, medallion 99, could also function as a decorative item 99, on the front of the Y-shaped sleeve 83, and could feature a message 97, such as, an inscription, design, indicia, a statement, a rhyme, an alphabet, a numeral, a symbol, a visual message, a graphic image, a verbiage, just to name a few. The tab 99, tongue 99, medallion 99, that could be secured to the Y-shaped cord sleeve invention 83, using at least one securing means 81.

This invention can be used to accessorize any of the headphones/earbuds currently in use, such as, for example, the Apple earbuds, as well as, any other earbuds which are similar in size, shape, or length. This invention allows the user to personalize/individualize their earbuds, as for example, right now Apple's earbuds products only comes in white, and therefore a user can put sleeve 23, 43, 53, 63, 73, 83, according to his/her personal taste. In addition to this, the Y-Junction or cord split 29, 49, 59, 69, 79, 89 may also be directed toward personalization/individualization and comprise various shapes and expressions.

The invention is a simple design, a Y-shaped, minimally bulky, one-piece or multi-piece sleeve that may or may not be seamless 23, 43, 53, 63, 73, 83, with a hole/slit 24, 44, 54, 64, 74, 84, on the front, or center, or back, or side of the center of the Y in which the user could feed each of the three components of the headphones through. This invention allows for individualization, personalization, personal expression, protection (whether it be protection from elements or otherwise) of earbud cables while providing tangle resistance to the user while they use their earbuds and/or in storage.

The inventive sleeve 23, 43, 53, 63, 73, 83, can be produced in various color/pattern/fashion schemes, whether it is basic colors, school colors or colors of professional sports teams, to name a few. Also, another design potential would be to give specific shapes to the tab or hub 39, 99, such as, for example, a star, heart, circle, octagon, to name a few, to the middle of the Y or where the components will be fed through or any other appropriate location. One could also call this middle section the hole/slit 24, 44, 54, 64, 74, 84, or the hub or tab or medallion 39, 99. Also, in allowing the hub 39, 99, to come in various shapes, it would allow the inventive product to advertise certain logos or emblems on the face of the hub or tab 39, 99, such as, for example, “NY” or “NJ” in the center of the Y or a picture of a team mascot, company logo, or any organization/artwork for that matter. This hub or tab 39, 99, may also feature a sewn in symbol expression or representative patch 39, 99.

This inventive product 23, 43, 53, 63, 73, 83, could be sold under various brand names, such as, for example, “i-cord”, “u-cord”, “my-cord”, “e-Cord”, “Y-Cord”, “iCord”, “uCord”, “myCord”, “eCord”, “YCord”, to name a few.

Further, the earbud headphone cord sleeve may be made using any method or manufacturing process that may be used to produce/create a hollow flexible tube form, including a ‘Y’ shape out of fabric and/or non-fabric. Special attention should be paid to the cord split/hub 29, 49, 59, 69, 79, 89, of the earbud headphone sleeve. The front perspective of the earbud headphone sleeve 23, 43, 53, 63, 73, 83, where the tab 39, may feature various design features including but not limited to shapes, patterns, logos, and emblems. In addition, the Y-shaped earbud headphone sleeve 23, 43, 53, 63, 73, 83, itself may feature various color schemes or materials. Additionally, the ends of the Y-shaped Earbud Headphone sleeve 26, 27, 28, 46, 47, 48, 56, 57, 58, 66, 67, 68, 76, 77, 78, 86, 87, 88 may include a supplemental flexible material in order to keep the sleeve from moving or shifting away from the earpieces 10, 12, 30, 32, and the plug 17, 37.

FIG. 2, could also be considered to illustrate an embodiment of an earbud headphone sleeve 23, 43, 53, 63, 73, 83, from the back. From this perspective one can most easily demonstrate how the item will be applied to a generic pair of earbud headphones. As described earlier, the back of the hub/cord split or sleeve Y-junction 29, 49, 59, 69, 79, 89, will be where the user will be able to insert the earpieces 10, 12, 30, 32, and the plug 17, 37, into an opening 24, 44, 54, 64, 74, 84, whether it be a slit, hole, circle, or any other type of opening. The user will first insert each of the earpieces 10, 12, 30, 32, and the plug 17, 37, into the opening 24, 44, 54, 64, 74, 84, in the hub/cord split and feed each to their respective ends. A possible additional component may be required in order to smoothly and efficiently feed each of the three components through the Y-Shaped Sleeve 23, 43, 53, 63, 73, 83. This component will be constructed of but not limited to a plastic material and have the shape of a ‘bullet’ or ‘football’ in order to allow for ease of attaching the generic earbuds to the Y-Shaped Sleeve 23, 43, 53, 63, 73, 83.

The Y-shaped sleeve 23, 43, 53, 63, 73, 83, could made from a material selected from a group comprising, fabric, knit material, textile material, waterproof material, plastic, rubber, vinyl, washable material, composite material, natural fibrous material, and combinations thereof, to name a few.

It should be appreciated that the peripheral shape of the central opening or hole or slit 24, 44, 54, 64, 74, 84, could be selected from a group comprising of a rectangular shape, a triangular shape, a circular shape, an elliptical shape, a polygonal shape, an ornamental-type shape, a heart-type shape, an irregular shape, and combinations thereof, just to name a few.

It should be appreciated that the peripheral shape of the tab, tongue, hub, medallion, 39, 99, could be selected from a group comprising of a rectangular shape, a triangular shape, a circular shape, an elliptical shape, a polygonal shape, an ornamental-type shape, a heart-type shape, an irregular shape, and combinations thereof, just to name a few.

Thus it should be understood that the Y-shaped cord sleeve invention 23, 43, 53, 63, 73, 83, could have two or more tabs, tongues, medallions, hubs, such that the tab 39, tongue 39, medallion 39, hub 39, could be used to cover the Y-junction opening 24, 44, 54, 64, 74, 84, while the tab 99, tongue 99, medallion 99, hub 99, is used as a decorative item 99, on the front of the Y-shaped sleeve, and could feature a message 97, such as, an inscription, design, indicia, a statement, a rhyme, an alphabet, a numeral, a symbol, a visual message, a graphic image, a verbiage, just to name a few.

The material for the medallion or tab or tongue or hub 39, 99, could be selected from a group comprising, fabric, plastic, vinyl, washable material, composite, and combinations thereof, to name a few.

The at least one control device 41, could be selected from a group comprising a volume control button, a next selection button, a previous selection button, a repeat button, a rewind button, a fast forward button, a microphone, to name a few.

The securing means or device 71, 81, could be selected from a group comprising, magnets, rivets, hooks, hook and loop device, such as, a VELCRO device, buttons, snaps, zippers, male/female engaging members, to name a few.

It should be appreciated that the peripheral shape of the tab or tongue or medallion 39, 99, could be selected from a group comprising of a rectangular shape, a triangular shape, a circular shape, an elliptical shape, a polygonal shape, an ornamental-type shape, a heart-type shape, an irregular shape, and combinations thereof, just to name a few.

It should also be appreciated that the medallion 39, 99, could have at least one message or inscription 97, and wherein the message or inscription 97, could be selected from a group comprising of but not limited to a design, an indicia, a drawing, a photograph, a scenery, a picture, an illustration, a gesture, a smiley-type face, a phrase, a statement, a rhyme, an alphabet, a numeral, a symbol, a visual message, a graphic image, a verbiage, just to name a few.

The O-ring or O-rings 51, could be secured to at least one location on the Y-shaped sleeve 23, 43, 53, 63, 73, 83. It should be appreciated that the O-ring 51, provides tubular elasticity to the location wherein it is secured or associated with the Y-shaped sleeve 23, 43, 53, 63, 73, 83. The material for the O-ring 51, could be selected from a group comprising of an elastic material, a rubber material, a composite material, and a combination thereof, to name a few.

While the present invention has been particularly described in conjunction with a specific preferred embodiment, it is evident that many alternatives, modifications and variations will be apparent to those skilled in the art in light of the foregoing description. It is therefore contemplated that the appended claims will embrace any such alternatives, modifications and variations as falling within the true scope and spirit of the present invention.

What is claimed is:

1. A Y-shaped sleeve, comprising; at least one first sleeve having a first end forming an opening and a second end; at least one second sleeve having a first end forming an opening and a second end; and at least one joint cord sleeve having a first end forming an opening and a second end; wherein each second end of each said sleeve is joined to form a sleeve Y-junction; and wherein said sleeve Y-junction having at least one opening, and thereby forming said Y-shaped sleeve.

2. The Y-shaped sleeve of claim 1, wherein said Y-shaped sleeve is made from a material selected from a group consisting of fabric, knit material, textile material, a waterproof material, plastic, rubber, vinyl, washable material, composite material, a natural fibrous material, and combinations thereof.

3. The Y-shaped sleeve of claim 1, wherein peripheral shape of said sleeve Y-junction opening is selected from a group consisting of a rectangular shape, a triangular shape, a circular shape, an elliptical shape, a polygonal shape, an ornamental-type shape, a heart-type shape, an irregular shape, and combinations thereof.

4. The Y-shaped sleeve of claim 1, wherein location for said sleeve Y-junction opening is selected from a group consisting of sleeve front location, sleeve back location, sleeve side location, sleeve top location, and sleeve intersection location.

5. The Y-shaped sleeve of claim 1, wherein at least one medallion covers at least a portion of said Y-shaped sleeve.

6. The Y-shaped sleeve of claim 1, wherein at least one medallion covers at least a portion of said Y-junction opening, and wherein material for said medallion is selected from a group consisting of fabric, plastic, vinyl, washable material, composite, and combinations thereof.

7. The Y-shaped sleeve of claim 1, wherein at least one medallion covers at least a portion of said Y-shaped sleeve, and wherein peripheral shape of said medallion is selected from a group consisting of a rectangular shape, a triangular shape, a circular shape, an elliptical shape, a polygonal shape, an ornamental-type shape, a heart-type shape, an irregular shape, and combinations thereof.

8. The Y-shaped sleeve of claim 1, wherein at least one medallion covers at least a portion of said Y-shaped sleeve, and wherein said at least one medallion is secured to at least a portion of said Y-shaped sleeve by at least one means.

9. The Y-shaped sleeve of claim 1, wherein at least one medallion covers at least a portion of said Y-shaped sleeve, and wherein said at least one medallion is secured to at least a portion of said Y-shaped sleeve by at least one means, and wherein said at least one means are selected from a group consisting of magnets, rivets, hooks, hook and loop device, such as, a VELCRO device, buttons, snaps, zippers, and male/female engaging members.

10. The Y-shaped sleeve of claim 1, wherein at least one medallion covers at least a portion of said Y-shaped sleeve, and wherein said at least one medallion has at least one inscription, and wherein said inscription is selected from a group consisting of a design, an indicia, a drawing, a photograph, a scenery, a picture, an illustration, a gesture, a smiley-type face, a phrase, a statement, a rhyme, an alphabet, a numeral, a symbol, a visual message, a graphic image, and a verbiage.

11. The Y-shaped sleeve of claim 1, wherein said Y-shaped sleeve has at least one additional opening.

12. The Y-shaped sleeve of claim 1, wherein said Y-shaped sleeve has at least one additional opening, and wherein said at least one additional opening is for the accommodation of at least one control device.

13. The Y-shaped sleeve of claim 1, wherein said Y-shaped sleeve has at least one additional opening, and wherein said at least one additional opening is for the passage of at least one control device, and wherein said at least one control device is selected from a group consisting of a volume control button, a next selection button, a previous selection button, a repeat button, a rewind button, a fast forward button, a microphone, and combination thereof.

14. The Y-shaped sleeve of claim 1, wherein at least one O-ring is secured to at least one location of said Y-shaped sleeve.

15. The Y-shaped sleeve of Claim I, wherein at least one O-ring is secured to at least one location of said Y-shaped sleeve, and wherein said at least one O-ring provides tubular elasticity to said location.

16. The Y-shaped sleeve of claim 1, wherein at least one O-ring is secured to at least one location of said Y-shaped sleeve, and wherein material for said O-ring is selected from a group consisting of an elastic material, a rubber material, a composite material, and a combination thereof.

17. The Y-shaped sleeve of claim 1, wherein said Y-shaped sleeve has at least one first tab, and at least one second tab.

18. The Y-shaped sleeve of claim 1, wherein said Y-shaped sleeve has at least one first tab, and at least one second tab, and wherein said at least one first tab covers at least a portion of said at least one opening, and wherein said at least one second tab is a decorative feature of said Y-shaped sleeve.

19. A combination Y-shaped sleeve and a Y-shaped earbud/headphone cord, comprising:
(a) at least one first sleeve having a first end forming an opening and a second end, at least one second sleeve having a first end forming an opening and a second end, and at least one joint cord sleeve having a first end forming an opening and a second end, wherein each second end of each said sleeve is joined to form a sleeve Y-junction, and forming a Y-shaped sleeve;
(b) at least one first earbud/headphone cord having a first end and a second end, at least one second earbud/headphone cord having a first end and a second end, and at least one joint earbud/headphone cord having a first end and a second end, wherein each second end of each said cord is joined to form a cord Y-junction, and forming a Y-shaped earbud/headphone cord; and
(c) said sleeve Y-junction having at least one opening for the passage of said first cord, said second cord, and said joint cord, such that said first end of said first cord exits said first opening in said first sleeve, said first end of said second cord exits said first opening in said second sleeve, said first end of said joint cord exits said first opening in said joint sleeve, and wherein each of said second end of each of said cord are securely contained inside said sleeve Y-junction.

20. A Y-shaped sleeve, comprising; at least one first sleeve having a first end forming an opening and a second end; at least one second sleeve having a first end forming an opening and a second end; and at least one joint cord sleeve having a first end forming an opening and a second end; wherein each second end of each said sleeve is joined to form a sleeve Y-junction; said sleeve Y-junction having at least one opening for the passage of said earbud/heaphone cords; at least one O-ring secured to at least one sleeve; and wherein said at least one O-ring provides tubular elasticity to said at least one sleeve.
